(19) United States
(12) Patent Application Publication
(10) Pub. No.: US 2008/0195878 A1
(43) Pub. Date: Aug. 14, 2008

(54) Control Scheme for Binary Control of a Performance Parameter

(75) Inventors: Rinze Ida Mechtildis Peter Meijer, Herkenbosch (NL); Francesco Pessolano, Veldhoven (NL); Jose De Jesus Pineda De Gyvez, Eindhoven (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/629,718

(22) PCT Filed: Jun. 7, 2005
(86) PCT No.: PCT/IB05/51849

§ 371 Date: Nov. 5, 2007

(30) Foreign Application Priority Data
Jun. 15, 2004 (EP) 04102713.7

(51) Int. Cl. G06F 1/32

(52) U.S. Cl. 713/322

(57) ABSTRACT

The present invention relates to a control system and method of controlling at least one performance parameter of an integrated circuit. The at least performance parameter is controlled based on a control word. However, the signaled control information is reduced to a binary control signal simply instructing increase or decrease of said at least one performance parameter. This is achieved by modifying the control word in accordance with the binary control signal, e.g., by using the binary control signal to define a binary value shifted into a shift register means (31). Thereby, a fast and simple control functionality can be provided, which does not require any further hardware to adjust the performance parameter.

The present invention relates to a control system and method for controlling at least one performance parameter of an integrated circuit (IC). Additionally, the present invention relates to a method of generating an application program for controlling operation of the IC.

As silicon technology scales towards smaller feature sizes, the increasing circuit density and the increasing operating frequency drive the need to reduce the power consumption of ICs. For each subsequent technology generation, the power supply voltage has been reduced, which has proven to be an effective way to lower the power consumption. To maintain transistor performance, both its threshold voltage and gate oxide thickness has been reduced at the cost of increased leakage power.

From 90 nm technology onwards, the performance of systems on chip (SoC) may severly be hampered by excessive transistor leakage and the impact of local and global process variability. Therefore, strategies are being developed and used for solving this problem by means of regulating or controlling in real-time design parameters or performance parameters, such as power supply and frequency of operation under constrained performance conditions. The objective of such an approach is to adapt the chip, e.g. an isolated island or IP (Intellectual Property), a cluster of IPs or an SoC, so that a certain level of performance is guaranteed, like the lowest power consumption of a desired operating frequency. When the performance demand is low, the power supply is lowered, delivering reduced performance but with a substantial power reduction. On the other hand, for high performance demands, the highest supply voltage delivers the highest performance at the fastest designed frequency of operation. Furthermore, such an approach can be used for tracking process and temperature variations.

Miyazaki et al describe an autonomous and decentralize system in ‘An autonomous decentralized low-power system with adaptive-universal control for a chip multi-processor’, IEEE International Solid State Circuits Conference, Digest of Technical Papers, San Francisco, USA, 8-13 Feb. 2003, pages 108-109, where each processor can operate at a minimum power consumption while maintaining specified performance. The power supply and clock are supplied to each module by global-routing lines, and each module is equipped which a voltage regulator and clock divider. A self-instructed look-up table in each module determines the voltages and frequency applied to the respective module. A compound built-in self test unit measures the performance of each module during the initial chip-testing phase and sends the data to each look-up table for memorization and use.

Conventional performance control schemes so far implementing the above real-time approach are based on receiving one or more performance indicators that normally correspond to desired clock frequency and supply voltage provided to the controlled circuit or system from an external agent, typically a software application. This makes the external agent the intelligence behind the manipulation of electrical parameters like power supply and operating frequency. This also implies that the application must be built with some sort of knowledge of the hardware.

However, the performance indicators require lots of bits and therefore introduce more complexity to the design. Furthermore, the control is fully performed by the application which thus has to know how the hardware reacts to its commands. The implementation of such control schemes needs internal loops and decoders for transforming performance indicators into supply and frequency values.

It is therefore an object of the present invention to provide a more simple adaptive control scheme for controlling at least one performance parameter of an integrated circuit.

This object is achieved by a control system as claimed in claim 1, by a control method as claimed in claim 7, and by a method of generating an application program, as claimed in claim 8.

Accordingly, the philosophy of giving performance indication is replaced by simply requesting for more or less performance using a binary control signal. This leads to a very simplified implementation based on the shift register means or FIFO (First-In-First-Out) and the adjusting means which are controlled by the control word stored in the shift register means of FIFO. This proposed simplified control scheme does not require any hardware to realize LUTs, or finite state machines (FSMs) to adjust the performance parameter.

As an example, the at least one performance parameter may comprise at least one of a power supply voltage and a clock frequency, wherein the adjusting means may comprises a variable resistor, which is connected between a power supply terminal and the integrated circuit, and a clock generator for generating a clock signal supplied to the integrated circuit. Specifically, the dual-control functionality may be obtained by supplying a first group of bits of the control word stored in the shift register means as a first control word to the variable resistor means, and by supplying a second group of bits of the control word as a second control word to the clock generator. The first group of bits may correspond to odd-numbered bits and the second group of bits may correspond to even-numbered bits, for example. Of course, other allocations of the bits of the control word may be used, as well. Moreover, more then two performance parameters may be controlled by dividing the control word into more than two groups of bits. Thereby, a simple implementation of the performance control can be achieved, where only one shift register or FIFO memory is required for controlling several performance parameters.

The bit values of the first group of bits can be used to individually switch resistor paths of the variable resistor means. The variable resistor means thus adds additional resistance between the controlled circuit or circuit region and the power supply terminal, while the power supply voltage can be controlled by changing the series resistance value introduced by the variable resistor means. Thereby, no changes are required in the global power network of the whole integrated circuit. The variable resistor means may comprise transistor means connected in series between the controlled circuit or circuit region and the power supply terminal. In particular, the transistor means may comprise a first transistor connected between a first power supply input of the controlled circuit and a first power supply terminal, and a second transistor may be connected between a second power supply input of the controlled circuit and a second power supply terminal, wherein performance control means may be arranged to supply a first control signal to the first transistor and a second control signal to the second transistor, and wherein the first control signal may be an inversion of the second control signal. Each of the isolated circuit regions can thus be put into a standby mode when both first and second transistors are switched off to thereby reduce the circuit's power consumption to a minimum value.

The transistor means may be divided into a plurality of transistor segments each segment or subset of segments being connected to a bit of a dedicated control register which is set by the local control means. A discrete digital control of the resistance value can thus be introduced, wherein the control register can be easily programmed or reprogrammed at runtime to enable adaptive supply voltage control.

Additionally, the bit values of the second group of bits can be used to individually bypass delay sections of the clock generator. This enables continuous adjustment of the clock frequency based on bit values of the binary control word.

In the application generation means, the binary control value may be embedded for each instruction of the application program, for a fixed or variable application sector, or as a separate program. The application generation means may be implemented as a program product comprising code means for controlling execution of the claimed method steps when loaded into and run on a processor system. In particular, the program product may be downloadable from a communication network or may be stored on a record carrier for insertion to the processor system.

Further advantageous modifications are defined in the dependent claims.

In the following, the present invention will be described on the basis of a preferred embodiment with reference to the accompanying drawings in which:

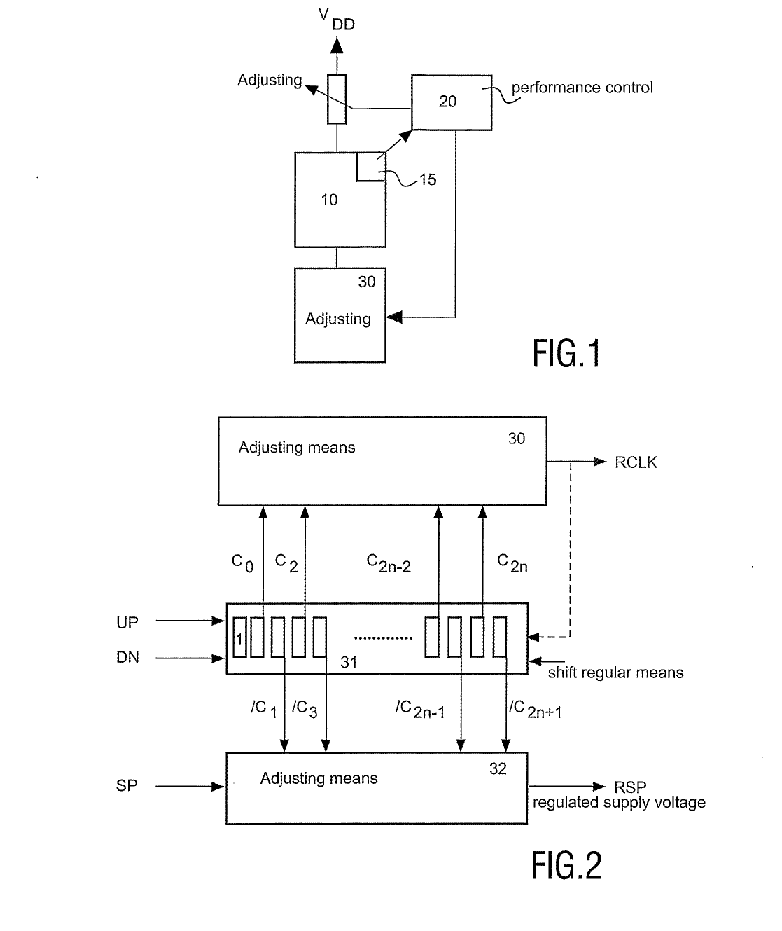

FIG. 1 shows a schematic block diagram of a controlled circuit with a performance control circuit for which the present invention can be used;

FIG. 2 shows a schematic block diagram of a control module according to the preferred preferred embodiment;

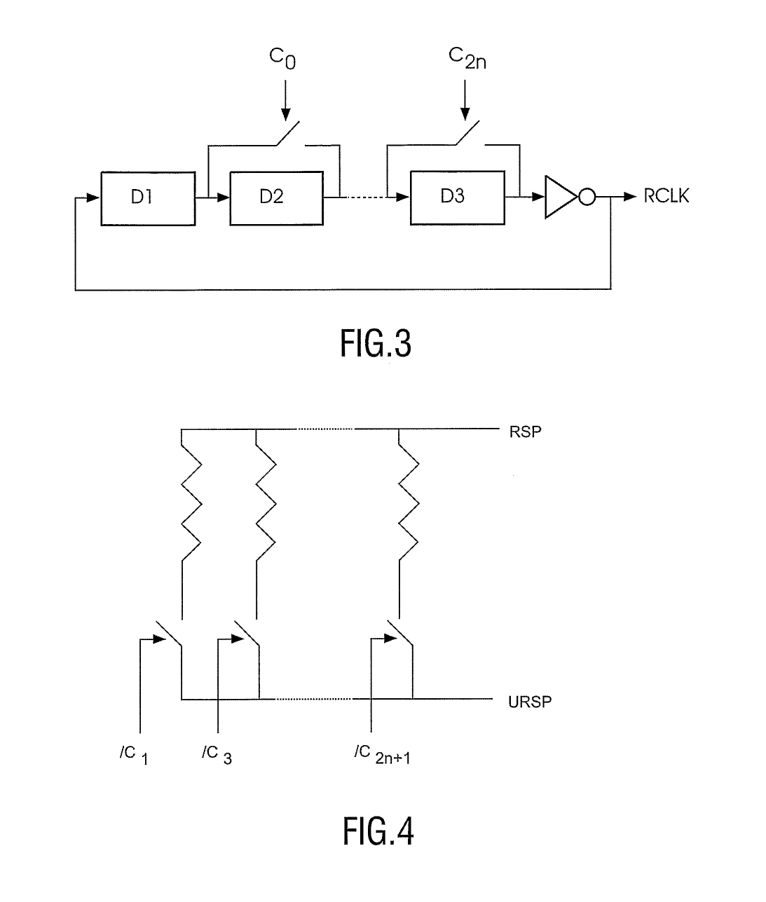

FIG. 3 shows a schematic circuit diagram of a linearly programmable clock generator according to the preferred embodiment;

FIG. 4 shows a schematic circuit diagram of a controllable parallel variable resistor according to the preferred embodiment;

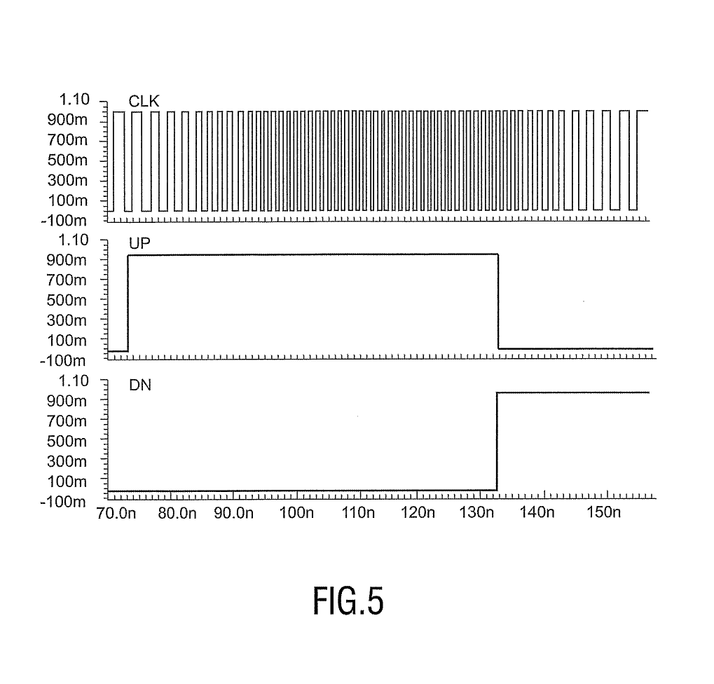

FIG. 5 shows a signaling diagram indicating an example of a clock waveform used in the preferred embodiment;

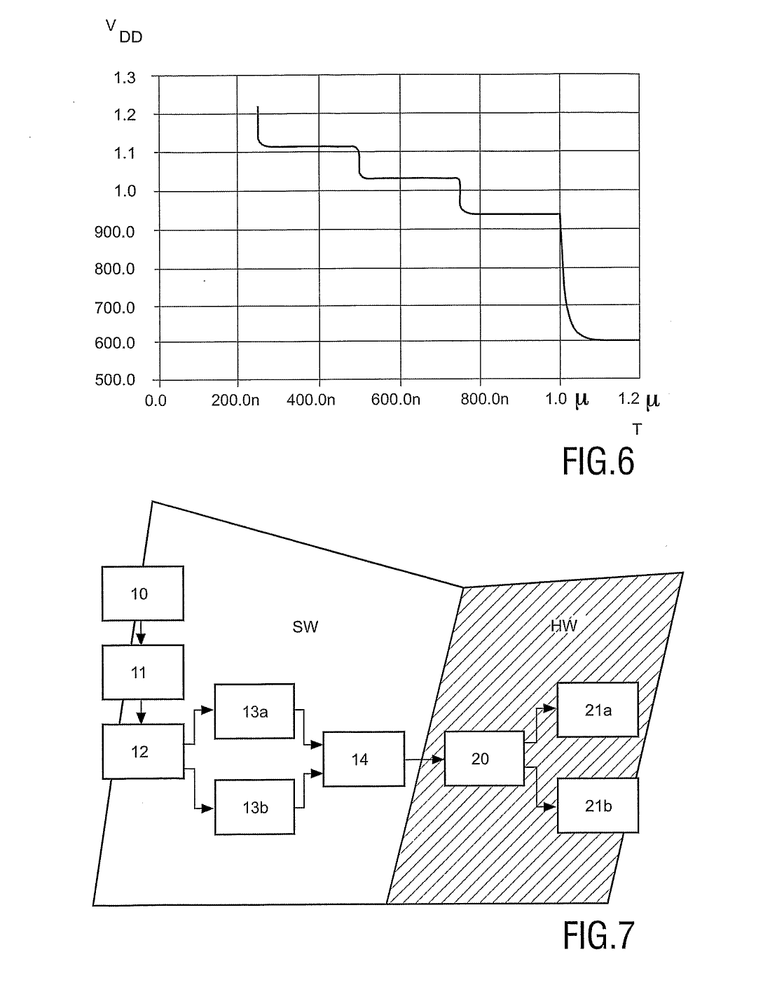

FIG. 6 shows a signaling diagram indicating an example of a supply voltage in the preferred embodiment; and

FIG. 7 shows a schematic flow diagram of the control function according to the preferred embodiment;

The preferred embodiments will now be described on the basis of an IC, which is partitioned into different islands. Each island can be contained in an isolated third well of a triple well CMOS (Complementary Metal Oxide Semiconductor) technology. Triple well CMOS technology allows a well of a first type, e.g. a P-well, to be placed inside a well of a second type, e.g. an N-well, resulting in three kinds of well structures: simple wells of the first type, simple wells of the second type, and wells of a third type, consisting of a well of the first type inside a deep well of the second type. The third type of well is useful for isolating circuitry within it from other sections on the chip by a reverse bias between the deep well of the second type and the substrate. Each well can be controlled and its working conditions can be modified depending on some parameters. The remainder of the chip can be controlled as well, depending on other parameters. Each island is operating at one or more utility values, and at least one utility value of a first island can be different from a corresponding utility value of a second island.

FIG. 1 shows a schematic circuit diagram of a control scheme according to the preferred embodiments, where an CMOS circuit 10 provided on an island is connected via variable resistor circuits or resistor means 32 to power supply voltage terminals, i.e. a reference voltage terminal, e.g. ground terminal GND or terminal V_{SS}, and a supply voltage terminal V_{DD}. Furthermore, a local clock generator unit 30 is allocated to the CMOS circuit 10 so as to generate an operating clock. The integrated circuit may be provided with a monitoring function or unit 15 for monitoring at least one working parameter related to a working condition of the integrated circuit, and at least two islands of the IC are provided with a local performance control device 20 for independently tuning or controlling at least one performance parameter for at least one island, based on the monitored at least one working parameter.

The at least one performance parameter may comprise one or more of supply power, transistor threshold voltage, or clock frequency. The transistor threshold voltage may be determined by a bulk voltage of some transistors in a computational island, e.g. the transistors of the processing core or module. The at least one monitored working parameter related to a global working condition of the integrated circuit may comprise at least one of circuit activity, circuit delay, power supply noise, logic noise margin values, threshold voltage value or clock frequency value. A pre-set level of performance may relate to any or all of power consumption or speed of the integrated circuit.

According to the preferred embodiment, supply voltage and clock frequency are controlled by the performance control means 20, where the variable resistor means 32 serves to control the power supply voltage of the CMOS circuit 10 arranged on the island of the IC. The controlled supply voltage can thus vary in a wide range between 0 and V_{DD} Volts as a function of the different performance parameters like workload or required circuit performance. The proposed variable resistor 32 offers many advantages when it is used in SoC applications, such as adaptive control of the active power and energy consumption, adaptive control of leakage current, low area overhead when compared to DC-DC converters, simple digital control, and fast transient response. Furthermore, no additional external components, such as inductivities L or capacities C, are required as in case of DC-DC converters.

The variable resistor 32 may alternatively be implemented based on any semiconductor circuit or other circuit having a controllable resistor functionality or acting as a controllable resistance. Specifically, it can be implemented as a PMOS transistor and an NMOS transistor, which are connected in series with the CMOS circuit 10 of the island. These transistors add additional resistance between the CMOS circuit 10 and its supply lines. For example, a low resistance value is required to minimize the voltage drop when the circuit requires its maximum operating speed. The power supply voltage of the CMOS circuit 10, i.e. V_{DD}−ΔV, can be controlled by changing the series resistance value introduced by the transistors. In this way, no changes have to be made to the global network in case the chip or IC consists of multiple islands.

The concept of voltage islands can easily be merged with a globally-asynchronous-locally-synchronous (GALS) solution, in which individual voltage islands are operated in a synchronous manner, while the overall integrated circuit is operated in an asynchronous manner. The independent clock of an island can be adjusted by the performance control unit 20 as a function of different parameters such as workload or circuit performance, i.e., the clock generator unit 30 can be bound to the power supply of the island. However, it should be verified that the clock frequency fits to the island's speed by properly adjusting the power supply. This action, which could take place simultaneously for various islands, can easily be accomplished with the proposed supply voltage actuator.

When the performance demand is low, the power supply can be lowered, delivering reduced performance but with a substantial power reduction. For high performance demands, the highest supply voltage delivers the highest performance at the fastest designed frequency of operation.

The basic idea of the actuator according to the preferred embodiment is to replace the philosophy of given performance indication by simply requesting for more or less performance. This can be accomplished with a binary signal, i.e. at most two bit values, and leads to a very simplified implementation based on a shift register or first-in-first-out (FIFO) memory 31, the variable resistor 32 used to generate the controlled supply voltage for the controlled circuit 10, and the clock generator unit 30 which can be a linearly programmable clock generator.

FIG. 2 shows a generic implementation of this control scheme. Binary control signals UP and DN are provided by the local performance control unit 20 and indicate whether more or less performance is required. Both signals control the FIFO or shift register 31 and are used as push or pop signals. Alternatively, a single binary control signal could be used, which is supplied and split into a non-inverted and inverted version to obtain the UP and DN values.

The bits stored in the shift register 31 are sent to the variable resistor 32 and to the clock generator unit 30. In response thereto, the clock generator unit 30 generates a regulated clock RCLK, and the variable resistor 32 generates a regulated supply voltage RSP.

FIG. 3 shows a schematic circuit diagram of an example of the clock generator unit 30. According to FIG. 3, the clock generator unit 30 consists of a loop comprising an inverter and a plurality of delay sections D1 to D3 which can be bypassed based on control signals C₀, C₂, . . . , C₂ₙ, derived from the respective even bit positions of the shift register 31. Due to the fact that the total delay of the loop of the clock generator unit 30 determines the regulated clock frequency RCLK, the clock frequency can be controlled based on the bit values stored in the shift register 31.

FIG. 4 shows a schematic circuit diagram of an example of the variable resistor 32 connected between a regulated supply terminal RSP and an unregulated supply terminal URSP. The variable resistor 32 comprises a plurality of parallel resistor branches which can be individually switched based on control signals /C₁, /C₃, . . . , /C₂ₙ₊₁ obtained from an inversion or negation of the respective odd bit positions of the shift register 31. Of course, the controllable resistor circuit of FIG. 4 can be replaced by transistor segments, wherein the control signals are supplied to the control terminals of the transistor segments.

While increasing the number of logical ‘1’ values in the pattern, the total delay of the clock generator unit 30 is increased (as the number of active delay sections is reduced in FIG. 3) and the total resistance of the variable resistor 32 is reduced (as the number of open resistor branches in FIG. 4 increases).

The control scheme works as follows:

Initially, the shift register 31 will have a logical ‘1’ at its first bit position or slot and the remaining bit positions or slots are filled with logical ‘0’, which results in a pattern ‘100 . . . 000’. This ensures that the variable resistor is at its minimum value (all resistor branches are connected or closed) and the clock generator provides the fastest clock corresponding to the lowest total delay (only one delay section D1 is active), which is however an arbitrary choice. When the local performance control unit 20 enables the control signal DN, the number of slots containing logical ‘1’ is increased by shifting a logical ‘1’ into the shift register 31 (shift to the right in FIG. 2) to obtain a pattern ‘110 . . . 000’. Depending on the new slot, which is set by the shift operation, i.e. odd or even slot, either the supply voltage or the clock frequency is reduced. On the other hand, when the local performance control unit 20 enables the control signal UP, the number of slots containing ‘1’ is decreased by removing a logical ‘1’ from the shift register 31 (shift to the left in FIG. 2) to obtain the pattern ‘100 . . . 000’. Depending on which slot is reset, i.e. odd or even slot, either the supply voltage or the clock frequency is reduced.

The sequence of actions is such that the clock frequency is reduced always before the supply voltage and the supply voltage is always increased before the clock frequency. In the proposed control scheme, rising (and of course releasing) the control signals UP and DN causes only one change in the state of the shift register 31. It could be also possible to feed the shift register 31 with the generated clock RCLK, as indicated by the dotted line in FIG. 2, so that a plurality of slots are set or reset as long as the control signal UP or DN is kept high.

The controlled circuit 10 operates at its maximum performance when the shift register 31 is filled only with logical ‘0’, while largest power savings are obtained in case the shift register 31 is filled only with logical ‘1’. Since the local performance control unit 20 controls the clock generator unit 30, it knows a clock frequency or operating frequency for a given data word of the shift register 31. On the other hand, a performance monitor, e.g. a ring oscillator and a counter, can be used to perform real-time measurements of the performance of the controlled circuit 10.

FIG. 5 shows signal diagrams indicating, from the top to the bottom, waveforms of the regulated clock signal RCLK, the control signal UP and the control signal DN. As can be gathered from FIG. 5, the regulated clock signal RCLK increases in frequency when the control signal UP is on a high logical state, while the regulated clock signal RCLK decreases in frequency, when the control signal DN is in a high logical state.

FIG. 6 shows a signal diagram indicating a waveform of the regulated supply voltage RSP or V_{DD} over time, where a stepwise voltage decrease based on a corresponding change of the content of the shift register 31 can be observed.

FIG. 7 shows a schematic flow diagram indicating processing steps of a proposed control scheme according to the third preferred embodiment, wherein the left portion of FIG. 7 corresponds to a software portion SW of the control scheme and the right portion of FIG. 7 corresponds to a hardware portion HW of the control scheme.

In step 10, the application is normally compiled by a standard compiler. Then in step 11, a standard profiler is used to extract a statistical profile of the application, which gives information on the behavior of the application and its performance requirements. Based on the statistic profile obtained in step 11, the performance indicators can be extracted in step 12. Thus, step 12 depends on the hardware that is going to be used. For the proposed solution, this assumption is not necessary and an indicator could only express the performance requirement of a section of the application in comparison with one of the other sections.

In step 13, the indicators or control values UP and DN are extracted in respective partial steps 13a and 13b. This extraction can be done independently from the hardware or tuned to the hardware, e.g. tuned to a specific initial guaranteed performance on which the control signals UP and DN are referenced to. In step 14, the control values UP and DN are embedded in the application as a two-bit or one-bit field for each instruction, for a fixed or variable application section or as a separate program. As already mentioned above, the UP and DN control values may as well be derived from a single binary control value or bit, wherein a first state of the single control bit relates to a high value of the control signal UP and a second state of the control bit relates to a high value of the control signal DN.

In step 20 of the hardware section HW, the control values UP and DN are extracted from the application. This extraction depends on step 14. Then, in step 21 the application is executed and the hardware is tuned depending on the control values UP and DN in respective partial steps 21a and 21b.

It is to be pointed out that the present invention is not restricted to the above preferred embodiment. Any kind of switching arrangement can be used for switching the transistor or resistor elements, which form the variable resistor 32. Moreover, only one or more than two performance parameters can be controlled by the proposed control scheme, using one or even more shift registers controlled by binary control signals UP and DOWN or the like.

It is further noted that the present invention is not limited to the above preferred embodiments and can be varied within the scope of the attached claims. In particular, the described drawing figures are only schematic and are not limiting. In the drawings, the size of some of the elements may be exaggerated and not drawn on scale for illustrative purposes. Where the term ‘comprising’ is used in the present description and claims, it does not exclude other elements or steps. Where an indefinite or definite article is used when referring to a singular noun, e.g. ‘a’ or ‘an’, ‘the’, this includes a plural of that noun unless something else is specifically stated. The terms first, second, third and the like in the description and in the claims are used for distinguishing between similar elements and not necessarily for describing a sequential or chronological order. It is to be understood that the embodiments of the invention described herein are capable of operation in other sequences than described or illustrated herein. Moreover, although preferred embodiments, specific constructions and configurations have been discussed herein, various changes or modifications in form and detail may be made without departing from the scope of the attached claims.

1. A control system for controlling at least one performance parameter of an integrated circuit, said control circuit comprising:
a) adjusting means for adjusting said at least one performance parameter of said integrated circuit;
b) performance control means for generating a binary control signal in order to instruct increase or decrease of said at least one performance parameter; and
c) shift register means for storing a control word supplied to said adjusting means, wherein said binary control signal defines a binary value shifted into said shift register means.

2. A control system according to claim 1, wherein said at least one performance parameter comprises at least one of a power supply voltage and a clock frequency, and wherein said adjusting means comprises a variable resistor, which is connected between a power supply terminal and said integrated circuit, and a clock generator for generating a clock signal supplied to said integrated circuit.

3. A control system according to claim 2, wherein a first group of bits of said control word stored in said shift register means is supplied as a first control word to said variable resistor means and a second group of bits of said control word is supplied as a second control word to said clock generator.

4. A control system according to claim 3, wherein said first group of bits corresponds to odd-numbered bits and said second group of bits corresponds to even-numbered bits.

5. A control system according to claim 3, wherein bit values of said first group of bits are used to individually switch resistor paths of said variable resistor means.

6. A control system according to claim 3, wherein bit values of said second group of bits are used to individually bypass delay sections of said clock generator means.

7. A method of controlling at least one performance parameter of an integrated circuit, said method comprising the steps of:
a) generating a binary control signal in order to instruct increase or decrease of said at least one performance parameter;
b) controlling said at least performance parameter based on a control word; and
c) modifying said control word in accordance with said binary control signal.

8. A method of generating an application program for controlling operation of an integrated circuit, said method comprising the steps of:
a) extracting a statistical profile of an application corresponding to said application program;
b) extracting at least one performance indicator based said statistical profile;
c) extracting a binary control value for instructing increase or decrease of at least one performance control parameter of said integrated circuit; and
d) embedding said binary control value in said application program.

9. A method according to claim 8, wherein said binary control value is embedded for each instruction of said application program, for a fixed or variable application sector, or as a separate program.

10. A program product comprising code means for controlling execution of the steps of claim 8 when loaded into and run on a processor system.
